(19) United States
(12) Patent Application Publication
(10) Pub. No.: US 2017/0208757 A1
(43) Pub. Date: Jul. 27, 2017

(54) HORTICULTURAL NUTRIENT CONTROL SYSTEM AND METHOD FOR USING SAME

(71) Applicant: Justin Jean Leonard VALMONT, Chilliwack (CA)

(72) Inventor: Justin Jean Leonard VALMONT, Chilliwack (CA)

(21) Appl. No.: 15/004,729

(22) Filed: Jan. 22, 2016

(51) Int. Cl. A01G 25/16; B01F 15/00; A01G 9/24; B01F 3/04; G06F 3/02; A01G 31/02; B01F 15/02

(52) U.S. Cl. CPC A01G 25/167; A01G 31/02; B01F 15/00974; B01F 15/0022; B01F 15/00311; B01F 15/0248; B01F 15/00279; B01F 3/04099; G06F 3/02; B01F 15/00422; B01F 15/00227; A01G 9/247; B01F 2003/04879; B01F 2215/008

(57) ABSTRACT

The present invention relates generally to a horticultural nutrient control system and method for using same. The invention relates to an apparatus, and related methods, for automatically formulating, storing, and dispensing a nutrient solution to one or more horticultural crop, comprising: a) a reservoir unit for receiving a nutrient solution, mixing said nutrient solution, and dispensing said nutrient solution to a corresponding horticultural crop, wherein said reservoir unit comprises: i) a vertical cylindrical tank terminating at a cone-shaped bottom outlet; ii) a plurality of vertical baffles extending from the interior surface of the reservoir unit; and iii) a plurality of fluid eductors positioned along the length of each baffle, said fluid eductors adapted to deliver said nutrient solution in combination with oxygen to said reservoir unit; b) a nutrient delivery assembly fluidly connecting a water source and a plurality of nutritional component sources to said reservoir unit, said nutrient delivery assembly adapted to controllably deliver said water and nutritional components to said reservoir unit through said plurality of fluid eductors; c) controller coupled to said nutrient delivery assembly and adapted to direct the delivery of said water and nutritional components to the reservoir unit; and d) a storage-control unit for housing at least a central processing unit, said nutrient delivery assembly, and said plurality of nutritional component sources, wherein said central processing unit is operably coupled to said controller.

### FIELD OF THE INVENTION

The present invention relates to the field of horticulture and, in particular, to methods and systems for formulating and delivering nutrient solutions to plants.

### BACKGROUND OF THE INVENTION

Increase in world population, decline in arable land, expanding environmental concerns, and the increasing demand for locally-grown food and related products, have contributed to the growth of alternative horticultural practices. In this respect, greenhouse horticulture has become the fastest growing sector of agriculture, ranging from commercial-scale horticulture to urban farming and specialist and hobby growers. A wide range of plants are being grown in greenhouses and include produce, ornamentals, and medicinal plants, produced at varying scales.

A variety of agricultural techniques are employed in greenhouse horticulture involving growth of plants in soil as well as soilless methods. For example, hydroponics is a method of growing plants using mineral nutrient solutions in water, without soil. Terrestrial plants may be grown with their roots in the mineral nutrient solution only, or in an inert medium, such as perlite or gravel. Certain techniques of hydroponics do not even require plant roots to be supported in any type of substrate but merely require the roots to be suspended and wetted with atomized nutrient solution, e.g., aeroponics. In hydroponics, the plant roots are constantly provided with water, oxygen and nutrients. The requirements for these elements vary between plant type and growth stage of the plant throughout the growth cycle. The challenge for the grower is to keep up with the plants' needs and to avoid damaging plants with excesses or deficiencies of minerals, extremes in pH and temperature, or a lack of oxygen.

Irrespective of the particular technique, the success of greenhouse horticulture primarily lies in the control and management of growth conditions, in particular, the nutrient solution. Consideration of the nutritional composition, pH, EC (electrical conductivity), temperature, oxygen content, etc. of the nutrient solution, over the various stages of a crop's lifecycle for the particular type of plant, must be made. Controlling these parameters has been facilitated by various computer technologies and automation tools.

Computer-controlled in-line nutrient mixing systems are available that allow automated injection of nutrient concentrates directly into water lines (e.g., Easy Feed Systems, Oakland, Calif.). These systems comprise a series of chemical injectors that draw nutrient concentrates from concentrate tanks and discharge these concentrates directly into the water line for distribution to the plants. Such systems do not rely on reservoirs for mixing nutrient solutions and consequently mixed nutrient compositions cannot be stored for later use.

U. S. Patent Publication No. 2013/0283689 describes a method and system for examining a source water to determine its chemical and biochemical make-up, and formulating an appropriate nutritional formulation for mixing with the source water directly in a hydroponic pond in which the plants are grown. The system is further described as capable of controlling oxygen content of the nutrient solution in the hydroponic pond, through the use of a controller system. The system allows for the nutrient solution to be monitored and controlled in culture where the plants are grown.

U.S. Pat. Nos. 7,937,187 and 7,809,475 describe a computer controlled fertigation system comprising a central processing unit which receives data from a sensor for measuring total water consumption by a plant. Based on this data, the central processing unit directs the preparation of a nutritional solution by instructing the transfer of fertilizers from holding tanks to be delivered to mixing tanks. The holding tanks and mixing tanks are situated in a fertigation room and connected through distribution lines to where the plants are grown. Such systems are designed for commercial-scale operations where space is available to accommodate a fertigation room.

Systems available to date are designed for large scale commercial operations and cannot easily be customized for small scale horticulture that are most frequently seen with specialty, for example medicinal, and craft-grown crops. In such cases, nutrient solutions are typically prepared, monitored, and distributed by manual methods such as hand blending which is cumbersome, work intensive, and can be inaccurate. A continuing need therefore exists for a horticultural nutrient control system that is adaptable to the needs of smaller scale operations.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

The present invention relates generally to a horticultural nutrient control system and method for using same. In accordance with one aspect, the invention relates to a horticultural nutrient control system for formulating, storing, and dispensing a nutrient solution to one or more horticultural crop, comprising:

a reservoir unit for receiving a nutrient solution, mixing said nutrient solution, and dispensing said nutrient solution to a corresponding horticultural crop;
a nutrient delivery assembly fluidly connecting a water source and a plurality of nutritional component sources to said reservoir unit, said nutrient delivery assembly adapted to controllably deliver said water and nutritional components to said reservoir unit;

a controller coupled to said nutrient delivery assembly and adapted to direct the delivery of said water and nutritional components to the reservoir unit; and

a storage-control unit for housing at least a central processing unit, said nutrient delivery assembly, and said plurality of nutritional component sources, wherein said central processing unit is operably coupled to said controller.

In accordance with another aspect, the invention relates to a horticultural nutrient control system for formulating, storing, and dispensing a nutrient solution to one or more horticultural crop, comprising:

a reservoir unit for receiving a nutrient solution, mixing said nutrient solution, and dispensing said nutrient solution to a corresponding horticultural crop, wherein said reservoir unit comprises:

a vertical cylindrical tank terminating at a cone-shaped bottom outlet;

a plurality of vertical baffles extending from the interior surface of the reservoir unit; and

a plurality of fluid eductors positioned along the length of each baffle, said fluid eductors adapted to deliver said nutrient solution in combination with air or oxygen to said reservoir unit;

a nutrient delivery assembly fluidly connecting a water source and a plurality of nutritional component sources to said reservoir unit, said nutrient delivery assembly adapted to controllably deliver said water and nutritional components to said reservoir unit through said plurality of fluid eductors;

a controller coupled to said nutrient delivery assembly and adapted to direct the delivery of said water and nutritional components to the reservoir unit; and

a storage-control unit for housing at least a central processing unit, said nutrient delivery assembly, and said plurality of nutritional component sources, wherein said central processing unit is operably coupled to said controller.

According to one embodiment, the horticultural nutrient control system described herein comprises a nutrient delivery assembly that comprises:

a water valve associated with said water source, wherein said water valve is controllably actuated by said controller to regulate the flow of water entering the process line of said nutrient delivery assembly;

a reservoir inlet valve fluidly connecting said reservoir unit with an inlet end of said process line, wherein said reservoir inlet valve is controllably actuated by said controller to regulate the flow of fluid entering said process line from said reservoir unit;

a plurality of dosing manifolds fluidly connected to each of said plurality of nutritional component sources, said plurality of dosing manifolds each being controllably actuated by said controller to deliver a calculated dose of each corresponding nutritional component to said process line;

a plurality of sensors situated in said process line for measuring pH, oxygen saturation, electroconductivity, or combinations thereof, said plurality of sensors in communication with said central processing unit;

a reservoir outlet valve fluidly connecting said process line to said reservoir unit at an outlet end of said process line, wherein fluid controllably enters said reservoir unit; and

one or more pump and fluid gauge assemblies fluidly connected to said process line for regulating the flow of fluid through said nutrient delivery assembly.

In accordance with another aspect, the invention relates to a method for automatically formulating, storing, and dispensing a nutrient solution for a designated horticultural crop, comprising:

designating a horticultural crop for nutrient delivery;

inputting identifying and/or quantitative information for the designated horticultural crop into the central processing unit of the system as defined herein;

controllably dispensing water and nutritional components into said nutrient delivery assembly for mixing in said reservoir unit, wherein the controller regulates the dispensed amounts of water and nutritional components in accordance with the identifying and/or quantitative information;

analyzing data measured by at least one sensor in said nutrient delivery assembly and dispensing additional nutritional components as determined to be necessary for the designated horticultural crop; and

delivering the formulated nutrient solution to the horticultural crop by an irrigation device at a predetermined schedule.

### BRIEF DESCRIPTION OF THE DRAWINGS

These and other features of the invention will become more apparent in the following detailed description in which reference is made to the appended drawings.

FIG. 1 is a perspective view of a nutrient control system according to one embodiment of the present disclosure.

FIG. 2 is a perspective view of the reservoir unit of a nutrient control system according to one embodiment of the present disclosure.

FIG. 3 is a top view of the reservoir unit of FIG. 2, showing the interior of the reservoir unit.

FIG. 4 is a perspective view of the storage unit of a nutrient control system according to one embodiment of the present disclosure.

FIGS. 5A and 5B are a side section view and a front view, respectively, of the storage-control unit of FIG. 4.

FIG. 6 is a perspective view of the nutrient control system of FIG. 1 showing the interior of the storage-control unit.

FIG. 7 is a schematic diagram of the nutrient delivery assembly of a nutrient control system according to one embodiment of the present disclosure.

FIG. 8 is a schematic diagram of the nutrient control system of FIG. 1 in operation with an exemplary horticultural operation.

FIG. 9 is a flowchart illustrating the process carried out by the nutrient control system of FIG. 1, according to an embodiment of the present disclosure.

FIG. 10 is a graph showing the dissolved oxygen content (% DO) of a formulation during preparation by a standard method (▴) and by way of the nutrient control system of FIG. 1, according to an embodiment of the present disclosure ().

### DETAILED DESCRIPTION OF THE INVENTION

A horticultural nutrient control system is disclosed herein that is particularly suited for formulating customized small-batch solutions. The nutrient control system of the present disclosure is a compact system for automated customizeable formulation, storage, and dispensing of nutrient solutions. According to certain embodiments, the system is self-contained and generally comprises two components consisting of a storage-control unit operationally connected to a reservoir unit. The system is designed to accommodate applications requiring custom, small-batch, nutrient solutions at volumes less than 5 gallons to volumes of up to 150 gallons at a time, according to certain embodiments. According to certain embodiments, the system can be designed to accommodate nutrient solution at volumes of as low as 10 gallons to volumes of up to 300 gallons. In further embodiments, the system can be designed to accommodate nutrient solutions at volumes of between about 50 gallons to volumes of up to 300 gallons. As will be understood by those skilled in the art, the system can be tailored for the preparation of smaller volumes of nutrient solution by adjusting components of the system such as the size capacity of the reservoir unit. The compact nature of the system further allows for a smaller footprint than current commercial scale systems, that is particularly advantageous to small-scale horticultural operations, for example, specialty and craft greenhouse or hydroponic horticultural operations, where space can often be limited. The compact, self-contained, design of the system further allows the system to be portable.

In certain embodiments, the system offers an all-in-one approach to automatic preparation, storage, and dispensing of nutrient solutions. The system is programmable to automatically prepare multiple formulations customized to the nutrient needs of a corresponding crop. Each formulation, according to certain embodiments, is prepared in the reservoir unit to mix the customized pre-programmed combination of nutrient concentrates, adjust and stabilize the pH of the solution to the required level, aerate the nutrient solution and/or supersaturate the nutrient solution with oxygen, and optionally adjust the temperature of the solution. The customized nutrient solution can then be stored in the reservoir until needed.

According to certain embodiments, the system can be programmed to prepare multiple, complex, nutrient solution formulations, each of which being custom blended to the needs of a particular crop of plants in a multi-zone horticultural operation. Each custom nutrient blend may be custom blended in small-batch volumes and dispensed from the reservoir unit to the corresponding zone of plants in the horticultural operation.

Multiple custom nutrient solutions can thus be prepared, stored, and dispensed to the desired crop zone, at the grower's discretion. In this way, a horticultural operation having multiple zones that each comprise different plant types or stages of plant development requiring a uniquely customized nutrient formulation, can be accommodated.

The reservoir unit of the system, according to certain embodiments, is configured to allow nutrient concentrates, water, and pH adjusting chemicals, to be added in measured amounts from sources that can be housed in the operatively connected storage-control unit of the system. The reservoir unit is configured to allow custom blending of all components of a nutrient solution to take place in a single vessel and stored until needed. The reservoir unit is generally cylindrical in shape with a coned bottom outlet. Nutrient concentrates can be added to the reservoir unit through a nutrient delivery assembly that fluidly connects the concentrates stored in the storage-control unit to the reservoir unit. A plurality of baffles and fluid eductors situated in the interior of the reservoir unit allow oxygen to be injected into the nutrient solution contained therein to create a “whirlpool” effect, or vortex, whereby the nutrient components can be thoroughly mixed in a top to bottom manner into solution, and simultaneously aerated, or in some embodiments supersaturated with oxygen, without mechanical mixing. In this way, the solution can be completely prepared in the reservoir unit and stored until ready to use.

Definitions

Unless defined otherwise, all technical and scientific terms used herein have the same meaning as commonly understood by one of ordinary skill in the art to which this invention belongs.

As used herein, the term “about” refers to an approximately +/−1-10% variation from a given value. It is to be understood that such a variation is always included in any given value provided herein, whether or not it is specifically referred to.

The term “plurality” as used herein means more than one, for example, two or more, three or more, four or more, and the like.

The use of the word “a” or “an” when used herein in conjunction with the term “comprising” may mean “one”, but it is also consistent with the meaning of “one or more”, “at least one”, and “one or more than one”.

As used herein, the terms “comprising”, “having”, “including”, and “containing”, and grammatical variations thereof, are inclusive or open-ended and do not exclude additional, unrecited elements and/or method steps. The term “consisting essentially of” when used herein in connection with an apparatus, system, composition, use or method, denotes that additional elements and/or method steps may be present, but that these additions do not materially affect the manner in which the recited apparatus, system composition, method or use functions. The term “consisting of” when used herein in connection with an apparatus, system, composition, use or method, excludes the presence of additional elements and/or method steps. An apparatus, system composition, use or method described herein as comprising certain elements and/or steps may also, in certain embodiments consist essentially of those elements and/or steps, and in other embodiments consist of those elements and/or steps, whether or not these embodiments are specifically referred to.

The term “fluid” as used herein includes liquids, gases, slurry solutions, gels, dispersions, suspensions of powders in an aqueous medium, or otherwise flowable materials or materials that are flowable.

The term “nutrient components” or “nutritional components” used interchangeably herein means macro or micro fertilizer components such as, for example and without limitation, any vitamins, minerals, organic components, and chemicals that are needed to support plant growth. Nutrient components can be in the form of pre-mixed nutrient concentrates that may be commercially available. Nutrient components may also include, without limitation, pH-adjusting and/or electroconductivity-adjusting chemicals.

The term “horticultural crop zone” or “crop zone” of a horticultural operation as used herein means a defined area or group of plants in a horticultural operation that share the same nutritional and/or watering needs due to being at the same stage of development or being of the same plant type, for example.

Horticultural Nutrient Delivery System

The horticultural nutrient control system, according to embodiments of the present disclosure, offers an all-in-one system that is adapted for formulating, storing, and dispensing a nutrient solution to one or more horticultural crop. The system is generally comprised of two units consisting of a storage-control unit operably connected to a reservoir unit. The units are compact and can be made to be portable. In this way, the horticultural nutrient control system is adaptable for use in relatively confined spaces often found with specialty greenhouse operations.

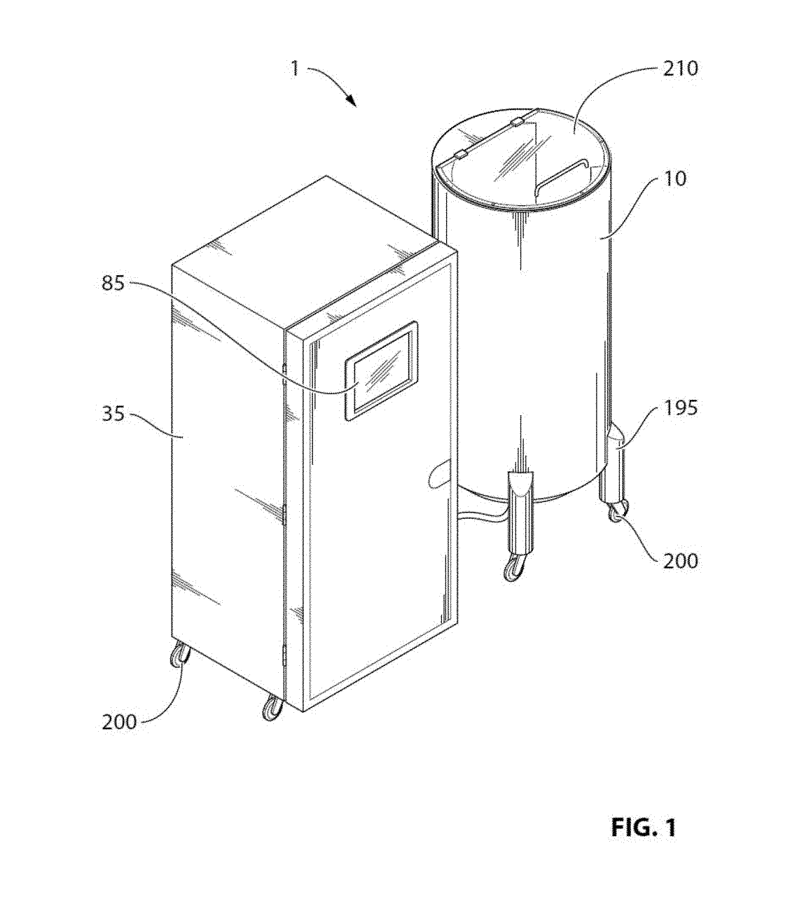

Referring to FIG. 1, the two main units of a horticultural nutrient control system of the present disclosure are shown. The reservoir unit 10 is generally a vertical cylindrical mixing tank that is configured for receiving a nutrient solution, mixing said nutrient solution, and storing and/or dispensing said nutrient solution to a corresponding horticultural crop. The reservoir unit 10 is operably connected to a storage-control unit 35 within which is typically housed a programmable logic control system (PLC), a nutrient delivery assembly, and a plurality of nutritional component sources (not shown).

The PLC comprises a central processing unit (CPU) that is coupled with a processor memory, wherein the processor memory includes a system software. The system software includes software encoded instructions that direct the CPU and coupled controllers to execute or instantiate the aspects of the horticultural nutrient delivery system described herein.

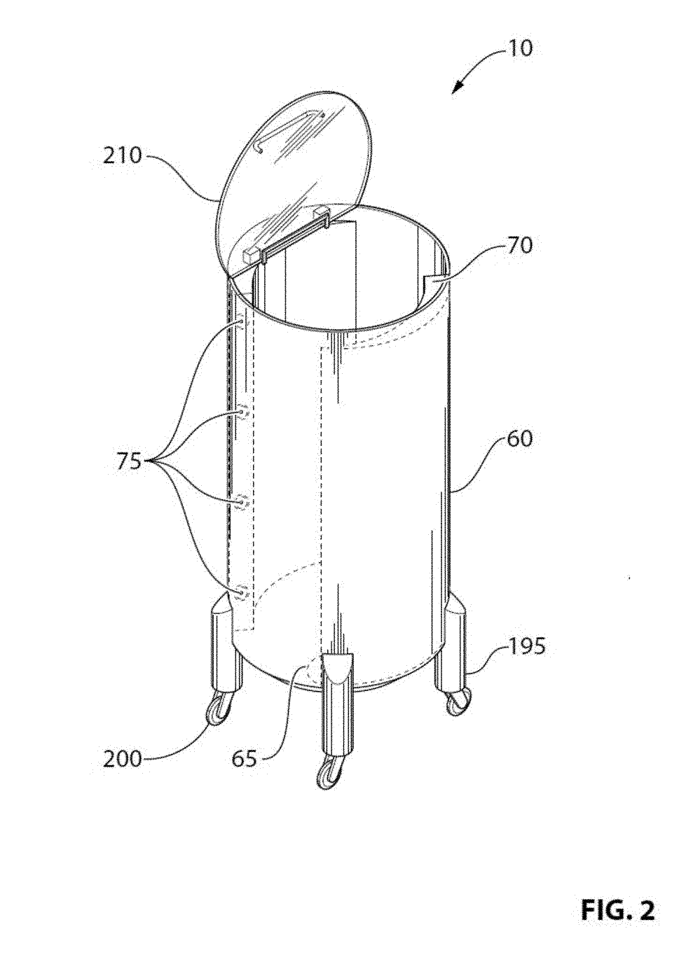

The reservoir unit 10 (FIG. 2) comprises a vertical cylindrical tank 60 having at least one inlet for receiving nutrient components and terminating at one or more bottom drain outlet 65 through which nutrient solution exits. The reservoir unit 10 will typically have a removable lid 210 at its top end and terminate in a cone-shaped bottom to allow for efficient drainage, however, according to alternative embodiments of the present disclosure, a flat bottom or a slope bottom is contemplated. According to embodiments of the present disclosure, the tank 60 terminates in a cone-shaped bottom outlet having a cone angle of no less than about 15°, no less than about 20°, no less than about 25° , no less than about 30°, no less than about 35°, no less than about 40°, or no less than about 54°. According to certain embodiments, the cone-shaped bottom outlet has a cone angle of less than about 54°. According to other embodiments, the cone-shaped bottom outlet has a cone angle of about 54°.

The tank 60 itself can range in size depending on the desired volume capacity, however, for most specialty horticulture operations the desired volume capacity can range from a volume of between about 10 to about 300 gallons. According to certain embodiments, the tank 60 has a tank volume of up to about 150 gallons. According to other embodiments, the tank 60 has a tank volume of up to about 300 gallons, 250 gallons, 200 gallons, 150 gallons, 100 gallons, 75 gallons, 60 gallons, 50 gallons, 40 gallons, 30 gallons, 20 gallons, or 10 gallons. To accommodate even smaller scale operations, a tank 60 having a volume capacity of less than 5 gallons can be used.

The tank 60 is made from standard materials known in the art. For example, according to certain embodiments, stainless steel, carbon steel, polypropylene, or polyethylene tanks can be used. According to preferred embodiments, the tank 60 is a stainless steel tank. The tank 60 can further be adapted with tank heating or cooling systems known in the art to allow the temperature of the nutrient solution to be controlled and/or adjusted to the horticulture crop of interest.

The reservoir unit 10 of the present disclosure does not require an agitator in order to achieve sufficient mixing of the nutrient solution. According to embodiments of the present disclosure, the nutrient solution is mixed within the tank 60 of the reservoir unit 10 without mechanical mixing. In this way, the temperature of the nutrient solution can be better controlled, as well the dimensions of the tank 60 design become less critical in achieving sufficient mixing. Tanks can thus be sized to be easily portable, for example sized to fit through a standard-sized door, and be housed in relatively confined spaces, without compromising adequate mixing of the nutrient solution. In this regard, according to certain embodiments, the tank 60 can be supported by legs 195 having casters 200 in any combination of swivel and rigidity in order to achieve the desired transport movement. According to certain embodiments, the casters can include a fixed brake. For example, casters 200 with sealed ball bearings can be used for minimal movement force as well as smooth operation. According to alternative embodiments, the tank 60 can be supported by a stand comprising such casters to facilitate movement. According to other embodiments, the tank 60 can be permanently fixed in position by bolt-down flanges to securely fix the legs of the tank to the floor for stability when required (not shown).

According to certain embodiments of the present disclosure, the tank 60 has a diameter of between about 1.5′ to about 5.5′, between about 2.0′ to about 4.5′, or between about 2.5′ to about 4.0′. According to a preferred embodiment, the tank 60 has a diameter of about 2.5′. The height of the tank 60 typically ranges from between about 4.0′ to about 12.0′, between about 4.5′ to about 10′, between about 5.0′ to about 8.0′, or between about 5.5′ to about 7.0′. According to a preferred embodiment, the tank 60 has a height of between about 4′5″ to about 6′5″. According to a further embodiment, the tank 60 has a height of about 5.5′. According to another embodiment, the tank 60 has a height of about 6.3′. It is further contemplated that a smaller tank 60 can be used for even smaller scale operations. According to such embodiments, the tank 60 can have a diameter of less than 12″.

Aerated/Oxygenated, Non-Mechanical Mixing-Baffled Reservoir Unit

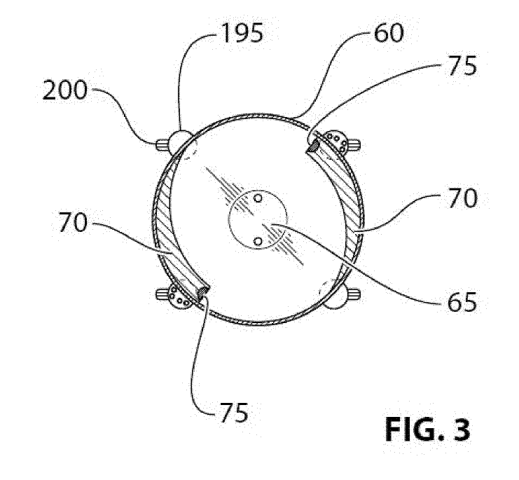

As discussed, the reservoir unit 10 of the present disclosure achieves non-mechanical mixing. As shown in FIGS. 2 and 3, the interior of the tank 60 is configured with at least two graduating baffles 70 that gradually extend from the interior surface of the tank 60. According to certain embodiments of the present disclosure, the tank 60 can comprise between two to four baffles 70. According to preferred embodiments, the tank 60 comprises two baffles 70. The baffles 70 extend approximately the full length of the tank 60, leaving some space at the bottom of the tank 60 to avoid the build-up of solids and extending just above the maximum liquid level of the tank 60. The baffles 70 are arranged approximately equidistant from each other in order to ensure efficient mixing of the nutrient solution. Each baffle 70 gradually extends from the interior surface of the tank 60 to a final width of between about 2.0″ to about 5″, between about 3.0″ to about 4.5″, between about 3.5′ to about 4.0″. According to a preferred embodiment, the baffle has a final width of about 2.5″. According to a further embodiment, the baffle has a final width of about 3.0″. In embodiments designed for even smaller scale operations, it is contemplated that the baffle can have a final width of less than 1″.

The final width of the baffle 70 will be sufficient to house a plurality of fluid eductors 75 which are positioned along the length of each baffle 70 and inject nutritional components and/or nutrient solution into the tank 60. The injected fluid enters the tank 60 in a naturally swirling or whirlpool fluid flow thereby allowing the fluid to mix as it is injected into the tank 60. According to certain embodiments, each baffle 70 comprises between three and seven fluid eductors 75 along its respective length. In some embodiments, each baffle 70 comprises four fluid eductors 75 along its respective length. According to preferred embodiments, the fluid eductors are venturi jet eductors, although it will be apparent to those skilled in the art that alternative fluid eductors may be used to achieve the same effect.

The direction of the baffles 70, according to certain embodiments, can be oriented to inject fluid into the tank 60 in a clockwise direction to create a clockwise swirling or whirlpool fluid flow. According to other embodiments, the baffles 70 can be oriented to inject fluid into the tank 60 in a counter-clockwise direction to create a counter-clockwise swirling or whirlpool fluid flow.

The nutrient solution enters the tank 60 through the fluid eductors 75 and may be recirculated through the fluid eductors 75 for thorough mixing. In such embodiments, nutrient solution is simultaneously aerated as it is injected into the tank 60 and in this way oxygen is introduced into the nutrient solution. According to further embodiments, the fluid eductors 75 can be further adapted to inject oxygen in combination with the nutrient solution into the tank 60. In this way, the nutrient solution can be saturated or supersaturated with oxygen if desired. According to such embodiments, the plurality of fluid eductors 75 is fluidly connected to an oxygen source.

The oxygen levels of water initially entering the system from a water source will not necessarily be consistent and will decline rapidly over time. As such it has proven difficult with prior art methods to consistently control oxygen levels. By introducing oxygen into the nutrient solution via the fluid eductors 75, as the solution enters the reservoir unit 10, the oxygen levels in the solution can be controllably increased so as to provide a more consistent nutrient solution.

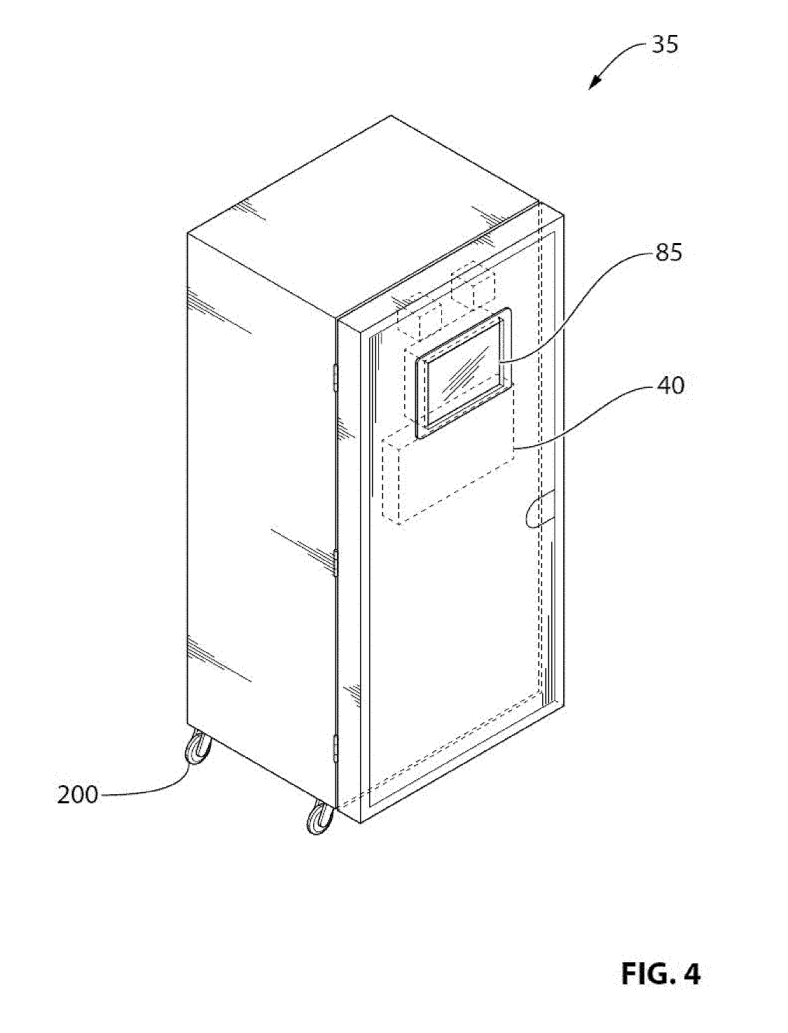

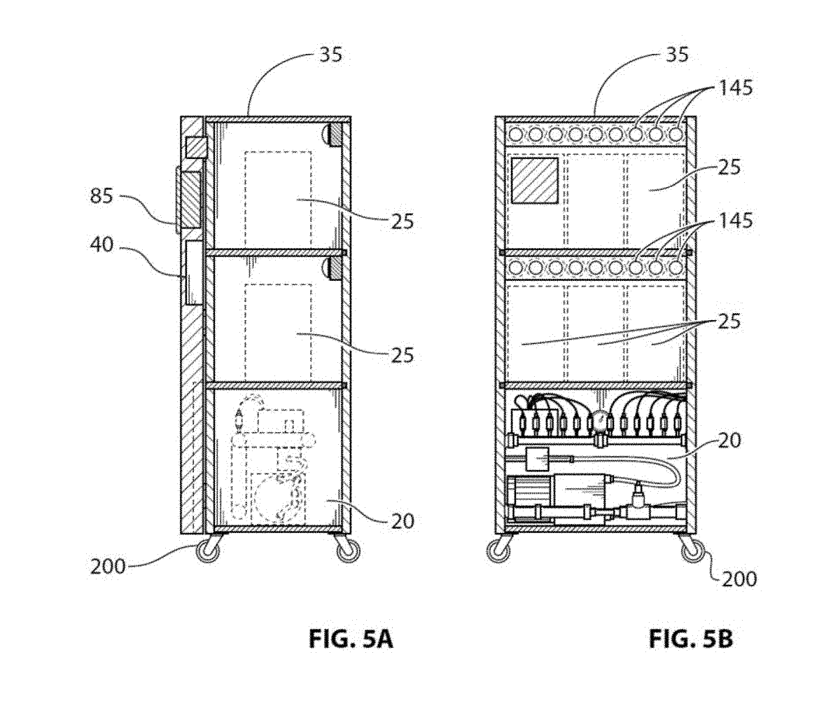

The reservoir unit 10 is operably connected to a storage-control unit 35. Referring to FIGS. 4, 5A, 5B, and 6, the storage-control unit 35 houses and comprises a power supply, programmable logic controller (PLC) with central processing unit (CPU) 40 having a data storage device and an exterior-facing interactive display 85. In addition to housing the PLC/CPU 40, the storage-control unit 35 houses a nutrient delivery assembly 20 which is operably connected to the PLC/CPU 40 and further fluidly connected to a plurality of nutritional component sources 25 also housed within the storage-control unit 35. In this way, the compactness and portability of the nutrient control system 1 is maintained. As with the reservoir unit 10, the storage-control unit 35 can also be supported on casters 200 in any combination of swivel and rigidity in order to achieve the desired transport movement. According to certain embodiments, the casters can include a fixed brake. For example, casters 200 with sealed ball bearings can be used for minimal movement force as well as smooth operation.

Custom Nutrient Formulation-Nutrient Delivery Assembly

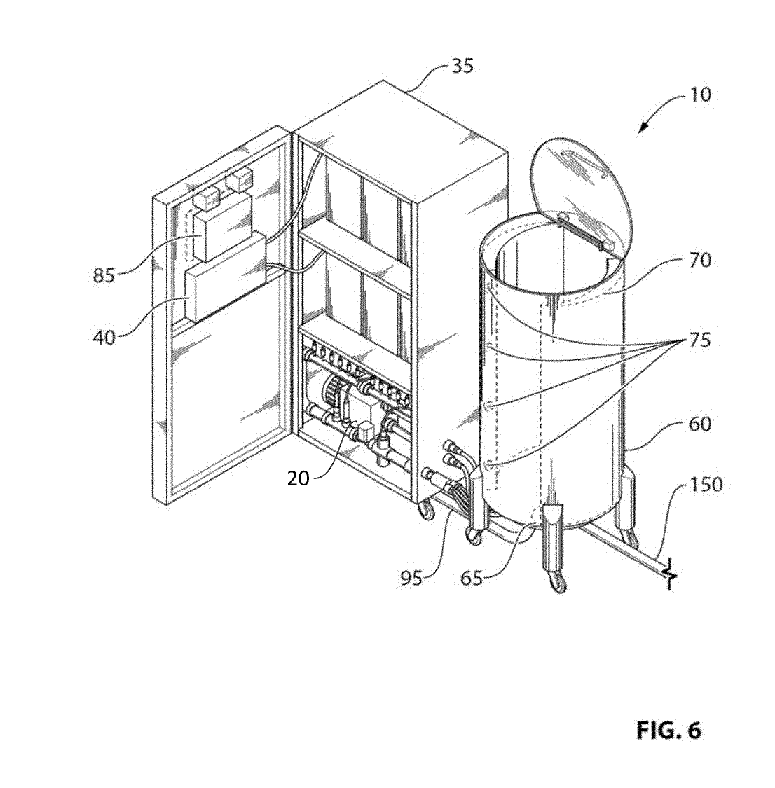

As shown in FIG. 6, the nutrient delivery assembly 20 is housed within the storage-control unit 35 and fluidly connects the reservoir unit 10 to a water source 15 and a plurality of nutritional component sources 25 that are controllably dispensed in calculated amounts to create a preprogrammed nutrient solution formulated for a targeted horticultural crop. The nutrient delivery assembly 20 is coupled to the controller in communication with the CPU to direct the preprogrammed dispensing of the water and nutritional components.

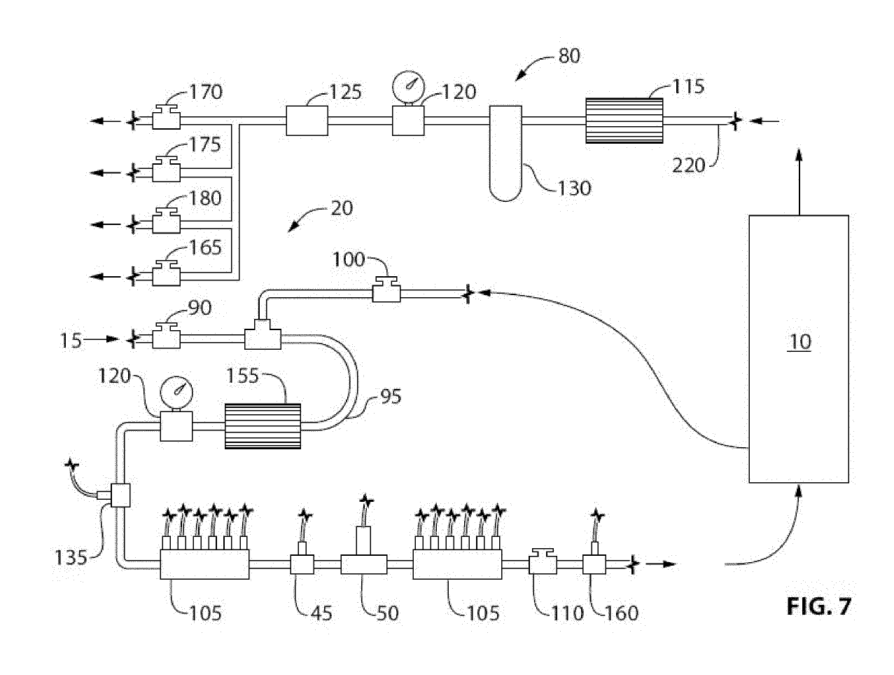

It will be appreciated by those skilled in the art that the nutrient delivery assembly 20 can be configured in a variety of arrangements for which one exemplary embodiment is described herein. Referring to FIGS. 6 and 7, the nutrient delivery assembly 20 comprises a process line 95 fluidly connecting the water source 15, nutritional component sources 25, and the reservoir unit 10. As illustrated by the exemplary embodiment shown in FIG. 7, the nutrient delivery assembly 20 forms a feedback loop with the reservoir unit 10 to allow the nutrient solution to be recirculated through the nutrient delivery assembly 20 whereby nutritional parameters can be monitored and adjusted, and thorough mixing can be achieved prior to storage and/or dispensing to the target horticultural crop.

According to embodiments of the present disclosure, the nutrient delivery assembly 20 comprises a water valve 90 associated with the water source 15 and controllably actuated by a controller to regulate the flow of water entering the process line 95. According to certain embodiments, the nutrient delivery assembly 20 comprises a flow meter, such as a magnetic inductive flow meter, whereby water flow is analyzed to determine and control the volume of water entering the process line 95. Nutrient solution from the reservoir unit 10 can also be controllably fed into the nutrient delivery assembly 20 via a reservoir inlet valve 100 connected to the reservoir unit 10 at a bottom outlet 65. According to certain embodiments, the reservoir inlet valve 100 is located downstream from the water valve 90 and under the control of a controller. Downstream of both the water valve 90 and reservoir inlet valve 100 is situated a plurality of dosing manifolds 105 fluidly connected to each of the plurality of nutritional component sources 25 and controllably actuated by a controller to deliver a calculated dose of each of the corresponding nutritional components into the process line 95. According to certain embodiments, the nutritional component sources are each equipped with a respective dosing pump 145 to allow for controlled delivery of a nutritional component to the respective dosing manifold 105. The dosing manifolds 105 are further equipped, in certain embodiments, with one-way check valves which allow the nutrient components to flow into the process line 95 without back pressure contamination.

Nutrient components for horticultural crops are commercially available in a variety of well-known forms and compositions. For example, without limitation, ready-to-use concentrated nutrient components such as FloraGro, FloraMicro, FloraBloom, Flora Blend, Flora Nectar and Floraliscious Plus (General Hydroponics) and Jungle Juice, pH Perfect, and Nirvana (Advanced Nutrients) are readily available and can be used in the system described herein. According to certain embodiments, the nutrient delivery assembly 20 can be configured to accommodate up to 18 nutrient components each individually dispensed via the dosing manifold 105. According to preferred embodiments, the nutrient delivery assembly 20 can be configured to individually dispense up to 18 nutrient components into the process line 95.

The feedback loop configuration of the system of the present disclosure facilitates any number of composition parameters of a nutrient solution to be monitored and adjusted to the desired level before application to a horticultural crop. In this way, it can be assured that a nutrient solution is suitable before application. According to certain embodiments, the pH, oxygen saturation, electroconductivity, or combinations thereof, of the nutrient solution can be monitored and adjusted in the process line 95. In such embodiments, the process line 95 comprises a plurality of sensors 45, 50 capable of monitoring such parameters that are in communication with the CPU to controllably dispense nutritional components suitable for adjusting such parameters. According to a certain embodiment, the process line 95 can comprise an acid and base manifold controllably actuated by a controller to deliver a calculated dose of acid and/or base into the process line 95 until the desired pH is achieved. According to certain embodiments, the process line 95 is orientated to slope so as to direct fluid into the section of the process line 95 in which the one or more sensors are located even between operations so as to maintain moisture levels for sensor maintenance.

A reservoir outlet valve 160 situated at an outlet end of the process line 95 provides for the controllable flow of nutrient solution into the reservoir unit 10, via the fluid eductors, where the nutrient solution is mixed, stored, recirculated through the nutrient delivery assembly 20 or dispensed to the targeted horticultural crop. One or more pump 155 and fluid gauge 120 assemblies fluidly connected to the process line ensures regulated flow of fluid through the nutrient delivery assembly 20. According to certain embodiments of the present disclosure, fluid is delivered through said nutrient delivery assembly 20 at a flow rate of between about 50 to about 100 litres/minute. According to other embodiments, the flow rate of fluid is between about 60 to about 80 litres/minute. According to preferred embodiments, the flow rate of fluid is between about 67 to about 71 litres/minute. According to certain embodiments, the fluid pressure within the nutrient delivery assembly 20 is maintained at a pressure of between about 3 to about 10 psi, between about 3 to about 7 psi, or between about 5 to about 8 psi.

Multi-Zone Delivery-Irrigation Assembly

Once formulation of a nutrient solution is completed in the nutrient delivery assembly 20 reservoir unit 10, the nutrient solution can be stored in the reservoir unit 10 or alternative storage container for later use, or directly applied to a target horticulture crop for which the nutrient solution was customized for.

Referring to FIG. 7, the reservoir unit 10 is fluidly connected to one or more irrigation device (not shown) through an irrigation assembly 80 that allows for controllable delivery of the nutrient solution from the reservoir unit 10 to one or more zones in a horticultural operation. The horticultural nutrient delivery system of the present disclosure can be adapted for use with commercially available irrigation devices that include, for example and without limitation, drip emitters, and various sprinkler systems. According to embodiments of the present disclosure, the irrigation assembly 80 comprises an irrigation line 220 that fluidly connects the reservoir unit 10, at a bottom outlet 65, to one or more irrigation device in each zone of the operation. The irrigation assembly 80 further comprises one or more pump 115 and pressure gauge 120 and/or regulator 125, under the control of a controller, to control the flow of nutrient solution through the irrigation line 220 whereby the nutrient solution is directed to one or more zones by way of corresponding irrigation valves 170, 175, 180, or is drained as waste 165. Each irrigation valve 165, 170, 175, 180 is controllably actuated by a controller in communication with the CPU to direct and regulate the delivery of the nutrient solution to the targeted zone.

According to certain embodiments, the irrigation assembly 80 further comprises an inline filter 130 to prevent particulates from clogging the irrigation assembly 80. According to preferred embodiments, the drain valve 165 will by-pass (not shown) the inline filter 130 so as to avoid unnecessary clogging of the filter.

According to embodiments of the present disclosure, the horticultural nutrient control system can be preprogrammed with preset fluid delivery programs allowing the operator to select the frequency of delivery, time of delivery, the targeted crop zone for delivery, the formulation of the nutrient solution to be delivered, the conditions (e.g., pH, temperature, salinity) of the nutrient solution for delivery, and the amount to be delivered, for example. As well, according to certain embodiments, the horticultural nutrient control system can further include one or more soil moisture sensors that are placed in each horticultural zone and which communicate with the CPU to automatically activate the nutrient control system based on the specific needs of the horticultural zone as determined by the soil moisture content. Data from the one or more sensors is analyzed by the CPU to determine activation of the horticultural nutrient control system to formulate and deliver a customized nutrient solution. In this way, the horticultural nutrient control system of the present disclosure can be automated.

The number of crop zones that can be accommodated by the horticultural nutrient delivery system of the present disclosure will depend on the volume of nutrient solution required and the volume capacity of the reservoir unit. According to certain embodiments, the horticultural nutrient delivery system of the present disclosure can be configured to deliver nutrient solution to up to 15 crop zones. According to further embodiments, the horticultural nutrient delivery system can be configured to deliver nutrient solution to up to 12 crop zones. According to other embodiments, the horticultural nutrient delivery system can be configured to deliver nutrient solution to up to 8 crop zones. According to further embodiments, the horticultural nutrient delivery system can be configured to deliver nutrient solution to up to 5 crop zones.

Method

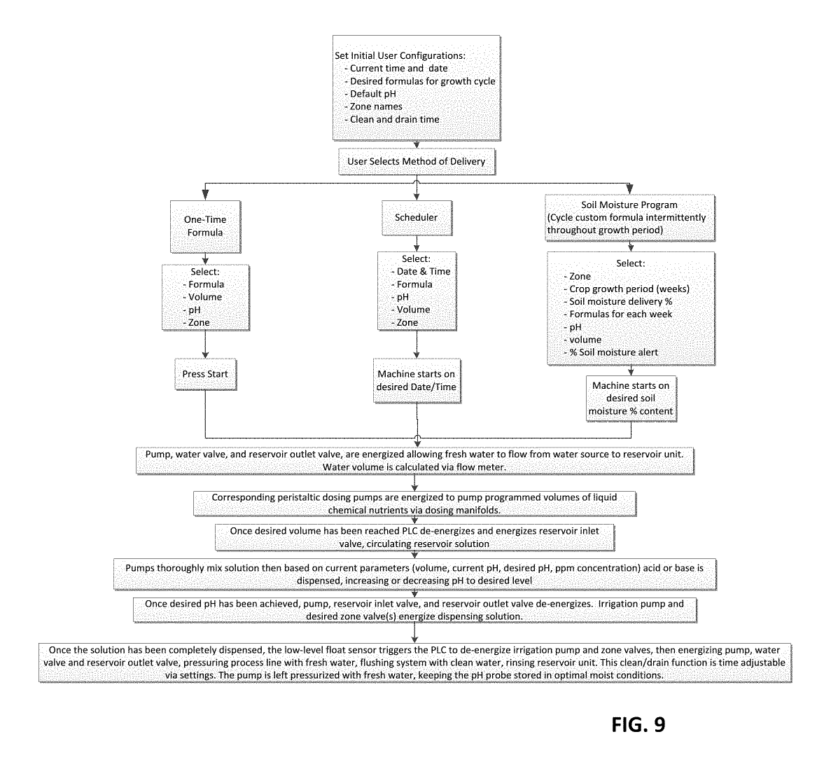

In exemplary operation, as illustrated in FIG. 9, the operator selects the desired fluid delivery mode suitable for the targeted horticultural crop zone or zones in an operation. For example, according to embodiments of the present disclosure, the nutrient delivery system can be preprogrammed for one-time delivery, regular scheduled delivery, or automatic delivery based on soil moisture levels. In such embodiments, the CPU will be preprogrammed with instructions for nutrient solution delivery including, without limitation, nutrient solution composition/formulation, delivery schedule, frequency and duration, soil moisture levels for automatic delivery, delivery volume, crop zone, pH, temperature, and salinity, for example. According to embodiments in which nutrient delivery is automatically activated based on soil moisture data, at least one soil moisture sensor is positioned in the designated horticultural crop.

The selected delivery program will be activated based on the identifying and/or quantitative information input by the operator into the CPU, for a designated horticultural crop. According to an exemplary embodiment, and referring to FIG. 7, the system will commence by energizing the water valve 90, pump 155, and reservoir inlet valve 100 to pressurize the process line 95 to the programmed pressure and flow rate. According to a certain embodiment, the process line 95 will be pressurized to about 3-7 psi and a flow rate of 67-71 litres/minute.

The required dosing pumps will then be energized to dispense the programmed amounts of selected nutritional components via dosing manifolds 105 into the process line 95. A magnetic inductive flow meter monitors the amount of water passing through the process line 95 until the desired volume has accumulated in the process line 95 to trigger de-energization of the water valve 90. The reservoir outlet valve 110 is then energized resulting in circulation of the nutrient solution through the reservoir unit 10 for a calculated period of time ensuring a thoroughly mixed solution. According to embodiments of the present disclosure, oxygen saturation, pH, salinity, and other parameters measurable by sensors located in the nutrient delivery assembly 20, can be monitored and adjusted during circulation of the nutrient solution.

According to certain embodiments, for example, the pH of the nutrient solution is monitored by a pH sensor 45 located in the nutrient delivery assembly 20. pH data is relayed to the CPU for analysis and based on the data collected, the acid/base manifold 135, 160 will be activated to dispense a calculated volume of acid and/or base to adjust the pH of the nutrient solution to the desired level for the particular programmed nutrient solution formulation. Adjustment and stabilization of the pH of the nutrient solution to the desired level can, therefore, be achieved quickly and automatically with little risk of overshooting which typically occurs using manual methods.

Once the desired parameters have been achieved, the pump 155, reservoir inlet valve 100, and reservoir outlet valve 110 are de-energized. The irrigation pump 115 and the zone valve 170, 175, 180 for the targeted zone is then energized and the nutrient solution is allowed to flow into the irrigation line 220 for dispensing to the targeted zone in accordance with the programmed schedule. According to certain embodiments, the nutrient solution is then dispensed via pressure regulated irrigation pump 115 through the irrigation line 220 at a flow rate of 0-82 litres/minute.

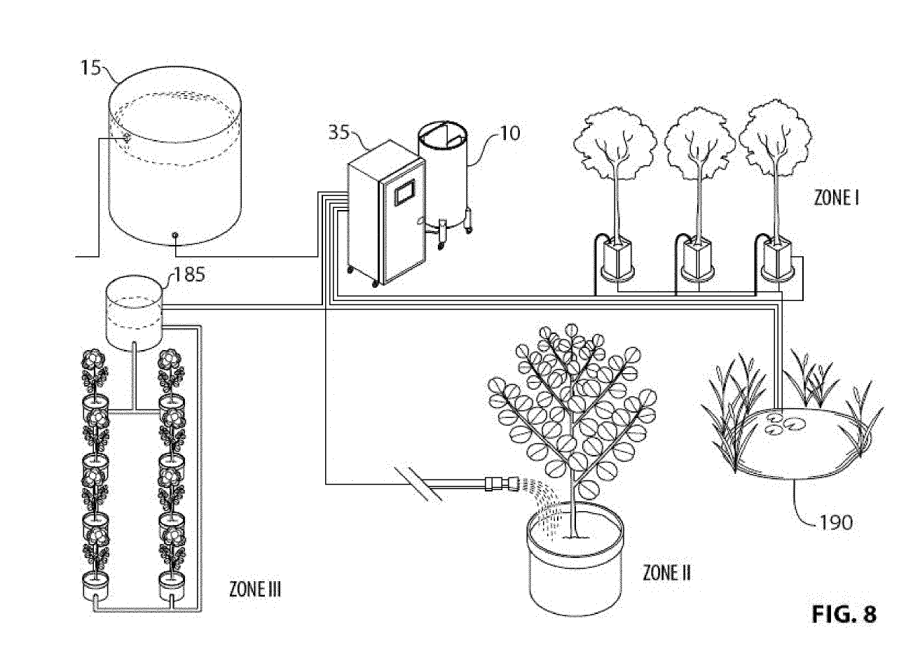

As illustrated in FIG. 8, the nutrient delivery system 10 of the present disclosure can be configured to deliver specific nutrient solutions to a horticultural operation comprising multiple crop zones of differing development stages and plant types in a customized manner.

To gain a better understanding of the invention described herein, the following examples are set forth. It will be understood that these examples are intended to describe illustrative embodiments of the invention and are not intended to limit the scope of the invention in any way.

### EXAMPLES

### Example 1

### Comparison of Dissolved Oxygen Content (% DO)

Dissolved oxygen is vital for the health and strength of the root system of a plant as well as being necessary for nutrient uptake. Typical manual methods for nutrient solution formulation utilize aeration methods such as a submerged air stone connected to an air pump, and manual agitation of the solution, in order to introduce and maintain dissolved oxygen levels in the nutrient solution at the time of delivery to the plants.

The dissolved oxygen content of a formulation prepared by such a standard manual method compared to the same formulation prepared by the nutrient control system of the present invention was investigated.

Method:

Standard Manual Method

135 gallons of a nutrient formulation (herein referred to as formulation “A”) was prepared in a 150 gallon livestock feed-trough style reservoir. Water was delivered from a 400 gallon water holding tank using a 1 hp pump. Temperature (° C.), Dissolved Oxygen (%), Conductivity (ppm), and pH was measured throughout the process of preparation. Formulation A was then manually measured and combined with the water in the reservoir and mixed within the reservoir using a ⅓ hp pump which was manually moved around the reservoir.

At the completion of preparation, the pH of the nutrient solution was manually adjusted to a desired pH of about 6.5±0.3. Once the pH was stabilized, mixing was continued for 20 minutes before nutrient solution was dispensed by scooping solution from the reservoir using a 5 gallon pail, a typical method of delivery to potted plants. The dissolved oxygen content of the dispensed nutrient solution was measured (Oakton DO600 Dissolved Oxygen/Temperature Meter) immediately after dispensation into the pail and at 1, 2, 3 and 4 minutes after dispensation.

Nutrient Control System

135 gallons of Formulation A was auto-formulated in the nutrient control system of the instant application. Water from the same 400 gallon water source used in the standard manual method was utilized in the control system. Temperature (° C.), Dissolved Oxygen (%), Conductivity (ppm), and pH was measured throughout the process of preparation. The pH of the nutrient solution was auto-adjusted until stabilized at a pH of about 6.5±0.3. Once the pH was stabilized, nutrient solution was dispensed from the reservoir of the nutrient control system via a 50 foot, ½ hose.

Dissolved oxygen was measured immediately after dispensation into a 2000 mL measuring cup, and at 1, 2, 3 and 4 minutes after dispensation.

Results:

Measurements were taken of the source water in the source water reservoir and of the source water during filling of either the standard or system mixing reservoir. Measurements were also taken during formulation, mixing of the formulation, immediately at dispensation, and at 1, 2, 3, and 4 minutes after dispensation of the nutrient solution.

TABLE 1
Nutrient Solution Measurements During Preparation

| | | | | Dissolved | Preparation |
|---|---|---|---|---|---|
| | | Conductivity | Temperature | Oxygen | Time |
| Sample | pH | (ppm) | (° C.) | (% DO) | (minutes) |
| Source | 6.7 | 55 | 20.6 | 98.6 | N/A |
| Water | | | | | |
| Formulation | 6.4 | 1110 | 21.2 | 86.4 | 100 |
| A (Standard | | | | | |
| Method) | | | | | |
| Completed | 6.4 | 1085 | 21.2 | 86.4 | 12 |
| Formulation | | | | | |
| A (Nutrient | | | | | |
| System) | | | | | |

Measurements are an average of 4 readings. % DO measured with Oakton DO 600 DO/Temp Meter, pH/ppm/temperature measured with Bluelab Guardian and Nutradip meters.

TABLE 2
Dissolved Oxygen Content of Final Nutrient Solution

| | Standard | Nutrient |
|---|---|---|
| Time of | Method | System |
| Measurement | (% DO) | (% DO) |
| Source Water | 98.6 | 87.6 |
| Filling | 81.2 | 99.3 |
| Formulation | 85.7 | 100.7 |
| Mixing | 86.4 | 101.3 |
| Dispensing | 87.8 | 106.9 |
| 1 min. post | 83.1 | 93.8 |
| 2 min. post | 81.9 | 84.9 |
| 3 min. post | 78.3 | 85.4 |
| 4 min. post | 76.9 | 86.0 |

Measurements are an average from 2 samples. Measurements were taken of the source water, at filling of the reservoir, during formulation, mixing of the formulation, immediately at dispensation, and at 1, 2, 3, and 4, minutes post dispensation.

Conclusions:

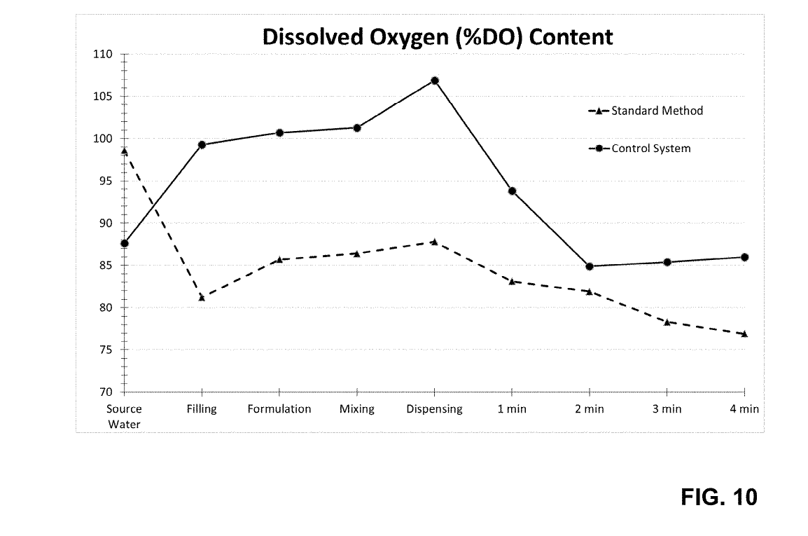

The standard manual method, relying on manual agitation of the nutrient solution with the assistance of a pump, was not able to increase oxygen into the solution let alone maintain dissolved oxygen levels of the source water during preparation of the formulation. Dissolved oxygen levels were found to rapidly decline throughout the process (FIG. 10). In contrast, jet injection and circulation of the nutrient solution during preparation in the control system resulted in an increase in dissolved oxygen levels of about 18% at dispensation. Even after dispensing of the nutrient solution, the dissolved oxygen levels remained higher than dissolved oxygen levels of the nutrient solution prepared by the standard method.

Referring to Table 1, the preparation time for preparing the nutrient solution from filling to mixing and stabilizing the pH, was improved by 88% with the control system over the time needed for preparation by the standard method.

The disclosures of all patents, patent applications, publications and database entries referenced in this specification are hereby specifically incorporated by reference in their entirety to the same extent as if each such individual patent, patent application, publication and database entry were specifically and individually indicated to be incorporated by reference.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1. A horticultural nutrient control system for formulating, storing, and dispensing a nutrient solution to one or more horticultural crop, comprising:
a) a reservoir unit for receiving a nutrient solution, mixing said nutrient solution, and dispensing said nutrient solution to a corresponding horticultural crop;
b) a nutrient delivery assembly fluidly connecting a water source and a plurality of nutritional component sources to said reservoir unit, said nutrient delivery assembly adapted to controllably deliver said water and nutritional components to said reservoir unit;
c) a controller coupled to said nutrient delivery assembly and adapted to direct the delivery of said water and nutritional components to the reservoir unit; and
d) a storage-control unit for housing at least a central processing unit, said nutrient delivery assembly, and said plurality of nutritional component sources, wherein said central processing unit is operably coupled to said controller.

2. The horticultural nutrient control system according to claim 1, further comprising one or more sensors for measuring the level of one or more nutritional components of said nutrient solution, said one or more sensors in communication with said central processing unit wherein data from said one or more sensors is analyzed to determine the amount of a corresponding nutritional component to deliver to the reservoir unit, wherein said one or more sensors measures pH, oxygen saturation, electroconductivity, or combinations thereof.

3. (canceled)

4. The horticultural nutrient control system according to claim 1, further comprising one or more sensors for measuring the soil moisture of a horticultural crop designated for delivery of said nutrient solution, wherein said one or more sensors is in communication with said central processing unit wherein data from said one or more sensors is analyzed to determine activation of said horticultural nutrient control system to formulate and deliver said nutrient solution.

5. The horticultural nutrient control system according to claim 1, wherein the reservoir unit comprises:
a) a vertical cylindrical tank terminating at a cone-shaped bottom outlet;
b) a plurality of vertical baffles extending from the interior surface of the reservoir unit; and
c) a plurality of fluid eductors positioned along the length of each baffle, said plurality of fluid eductors fluidly coupled to said nutrient delivery assembly, said fluid eductors adapted to deliver said nutrient solution in combination with air or oxygen to said reservoir unit.

6. The horticultural nutrient control system according to claim 5, wherein the fluid eductors are venturi jet eductors.

7. The horticultural nutrient control system according to claim 5, wherein the reservoir unit comprises at least two to four baffles.

8. (canceled)

9. The horticultural nutrient control system according to claim 5, wherein said plurality of fluid eductors are further fluidly connected to an oxygen source.

10. The horticultural nutrient control system according to claim 5, wherein the cylindrical tank has a volume capacity of up to about 150 gallons.

11. The horticultural nutrient control system according to claim 1, wherein said nutrient delivery assembly can be fluidly connected to up to eighteen sources of nutritional components, said sources of nutritional components being housed in said storage unit.

12. The horticultural nutrient control system according to claim 5, further comprising an irrigation assembly fluidly connected to said reservoir unit and adapted to controllably deliver said nutrient solution from said reservoir unit to said corresponding plant crop.

13. The horticultural nutrient control system according to claim 1, wherein said central processing unit further comprises:
a) a data storage device;
b) a display; and
c) optionally a keyboard and mouse.

14. The horticultural nutrient control system according to claim 1, wherein said nutrient delivery assembly comprises:
a) a water valve associated with said water source, wherein said water valve is controllably actuated by said controller to regulate the flow of water entering the process line of said nutrient delivery assembly;
b) a reservoir inlet valve fluidly connecting said reservoir unit with an inlet end of said process line, wherein said reservoir inlet valve is controllably actuated by said controller to regulate the flow of fluid entering said process line from said reservoir unit;
c) a plurality of dosing manifolds fluidly connected to each of said plurality of nutritional component sources, said plurality of dosing manifolds each being controllably actuated by said controller to deliver a calculated dose of each corresponding nutritional component to said process line;
d) a plurality of sensors situated in said process line for measuring pH, oxygen saturation, electroconductivity, or combinations thereof, said plurality of sensors in communication with said central processing unit;
e) a reservoir outlet valve fluidly connecting said process line to said reservoir unit at an outlet end of said process line, wherein fluid controllably enters said reservoir unit; and
f) one or more pump and fluid gauge assemblies fluidly connected to said process line for regulating the flow of fluid through said nutrient delivery assembly.

15. The horticultural nutrient control system according to claim 14, wherein said water valve is in communication with said central processing unit by way of a flow meter wherein data from said flow meter is analyzed to determine the volume of water entering said process line.

16. (canceled)

17. The horticultural nutrient control system according to claim 12, wherein the irrigation assembly further comprises an irrigation pump, pressure gauge, and pressure regulator, fluidly connected to the bottom outlet of said reservoir unit.

18. The horticultural nutrient control system according to claim 12, wherein said irrigation assembly further comprises a filter to prevent particulates from clogging the irrigation assembly.

19. The horticultural nutrient control system according to claim 3, wherein said horticultural nutrient control system comprises:
a) a pH sensor adapted to measure a pH of the nutrient solution; and
b) an acid/base delivery module, the acid/base delivery module fluidly connected to the nutrient delivery assembly and adapted to controllably release an acidic or basic agent into the fluid delivered to the reservoir unit.

20. A horticultural nutrient control system for formulating, storing, and dispensing a nutrient solution to one or more horticultural crop, comprising:
a) a reservoir unit for receiving a nutrient solution, mixing said nutrient solution, and dispensing said nutrient solution to a corresponding horticultural crop, wherein said reservoir unit comprises:
i. a vertical cylindrical tank terminating at a cone-shaped bottom outlet;
ii. a plurality of vertical baffles extending from the interior surface of the reservoir unit; and
iii. a plurality of fluid eductors positioned along the length of each baffle, said fluid eductors adapted to deliver said nutrient solution in combination with air or oxygen to said reservoir unit;
b) a nutrient delivery assembly fluidly connecting a water source and a plurality of nutritional component sources to said reservoir unit, said nutrient delivery assembly adapted to controllably deliver said water and nutritional components to said reservoir unit through said plurality of fluid eductors;
c) a controller coupled to said nutrient delivery assembly and adapted to direct the delivery of said water and nutritional components to the reservoir unit;
d) a storage-control unit for housing at least a central processing unit, said nutrient delivery assembly, and said plurality of nutritional component sources, wherein said central processing unit is operably coupled to said controller;
e) one or more sensors cooperatively engaged with said nutrient delivery assembly for measuring the level of the one or more nutritional components of said nutrient solution, said one or more sensors in communication with said central processing unit wherein data from said one or more sensors is analyzed to determine the amount of a corresponding nutritional component to deliver to the reservoir unit;
f) a pH sensor adapted to measure a pH of the nutrient solution, said pH sensor operatively connected to an acid/base delivery module, the acid/base delivery module fluidly connected to the nutrient delivery assembly and adapted to controllably release an acidic or basic agent into the fluid delivered to the reservoir unit; and
g) optionally, one or more sensors for measuring the soil moisture of a horticultural crop designated for delivery of said nutrient solution, wherein said one or more sensors is in communication with said central processing unit wherein data from said one or more sensors is analyzed to determine activation of said horticultural nutrient control system to formulate and deliver said nutrient solution.

21.-23. (canceled)

24. The horticultural nutrient control system according to claim 20, wherein the fluid eductors are venturi jet eductors.

25.-28. (canceled)

29. The horticultural nutrient control system according to claim 20, wherein said nutrient delivery assembly comprises:
a) a water valve associated with said water source, wherein said water valve is controllably actuated by said controller to regulate the flow of water entering the process line of said nutrient delivery assembly;
b) a reservoir inlet valve fluidly connecting said reservoir with an inlet end of said process line, wherein said reservoir inlet valve is controllably actuated by said controller to regulate the flow of fluid entering said process line from said reservoir;
c) a plurality of dosing manifolds fluidly connected to each of said plurality of nutritional component sources, said plurality of dosing manifolds each being controllably actuated by said controller to deliver a calculated dose of each corresponding nutritional component to said process line;
d) a plurality of sensors situated in said process line for measuring pH, oxygen saturation, electroconductivity, or combinations thereof, said plurality of sensors in communication with said central processing unit;
e) a reservoir outlet valve fluidly connecting said process line to said reservoir at an outlet end of said process line, wherein fluid controllably enters said reservoir; and
f) one or more pump and fluid gauge assemblies fluidly connected to said process line for regulating the flow of fluid through said nutrient delivery assembly.

30.-34. (canceled)

35. A method for automatically formulating, storing, and dispensing a nutrient solution for a designated horticultural crop, comprising:
a) designating a horticultural crop for nutrient delivery;
b) inputting identifying and/or quantitative information for the designated horticultural crop into the central processing unit of the system as defined in any one of claims 20 to 23;
c) controllably dispensing water and nutritional components into said nutrient delivery assembly for mixing in said reservoir unit, wherein the controller regulates the dispensed amounts of water and nutritional components in accordance with the identifying and/or quantitative information;
d) analyzing data measured by at least one sensor in said nutrient delivery assembly and dispensing additional nutritional components as determined to be necessary for the designated horticultural crop; and
e) delivering the formulated nutrient solution to the horticultural crop by an irrigation device at a predetermined schedule.
